(19) United States
(12) Patent Application Publication
(10) Pub. No.: US 2011/0083122 A1
(43) Pub. Date: Apr. 7, 2011

(54) METHOD AND SYSTEM FOR MASSIVE LARGE SCALE TEST INFRASTRUCTURE

(75) Inventors: Jih-Yin Chen, Berkeley, CA (US); Ashit Kumar Jain, San Jose, CA (US); Chris Chen, San Ramon, CA (US); John Akerley, San Francisco, CA (US); Mohit Chawla, Berkeley, CA (US); Aaron Arruda, San Francisco, CA (US); Cheng Leong, Fremont, CA (US); Bala Subramanian, Sunnyvale, CA (US)

(73) Assignee: salesforce.com, inc., San Francisco, CA (US)

(21) Appl. No.: 12/898,588

(22) Filed: Oct. 5, 2010

Related U.S. Application Data
(60) Provisional application No. 61/248,803, filed on Oct. 5, 2009.

(51) Int. Cl. G06F 9/44

(52) U.S. Cl. 717/124; 717/168

(57) ABSTRACT

An automated system is provided to support massive scale grid of machines in a rapid, multi-developer coding environment. The system has virtual testing environments that are created from template machines, supporting various software versions for various code branches. The grid is built by having a small subset of template machines (e.g. with Oracle 9g, 10g, and application server installations), images of the template machines, virtual machine instances created by applying one or more of the image templates, which then are used by the virtual testing environment. Upon receipt of code changes, changes are checked-out, compiled, tested on various test feeds on a virtual testing environment, which is destroyed and re-created after every test run. Any software version upgrades or bug fixes need to be applied only to the template machines. The number of virtual machines associated with any particular template machine is dynamically configurable to provision for optimal use of testing machines.

### CROSS-REFERENCES TO RELATED APPLICATIONS

The present application claims benefit under 35 USC 119(e) of U.S. provisional Application No. 61/248,803, filed on Oct. 5, 2010, entitled “METHOD AND SYSTEM FOR MASSIVE LARGE SCALE TEST INFRASTRUCTURE,” the content of which is incorporated herein by reference in its entirety.

### BACKGROUND OF THE INVENTION

The present invention relates generally to software testing in large scale grid environments, and more particularly for quality assurance automated testing of software on large scale infrastructure, in a rapid multi-developer coding environment.

A rapid development environment demands rapid rate of code change testing, which in turn demands rapid, scalable rebuilding of testing environments. The process of managing a grid of machines for these tests can be manual labor intensive. Compounding the problem, the development infrastructure and automation teams that support testing environments are generally smaller than production environments and heavily resource constrained.

In small de-centralized development teams, machines are built, managed, and provisioned manually to facilitate testing. Software patches are applied manually on a small number of machines, machines are moved around for load balancing manually, and the test environment of the machine is cleaned up manually to avoid spurious environment-based errors. However, in large teams with a high velocity of code changes per day, supported by a centralized test automation team, managing a grid of machines in the hundreds to thousands in a manual fashion is highly inefficient if not untenable.

The automation team typically supports testing of several branches of code at any one time (code lines). Different code lines may require different version of software installation and machine environment. The load across code lines changes regularly and machines must be moved around for load balancing, across these various environments. Machines require software upgrades and patches due to changes in software versions, platform selections, and bug fixes. Typical processes to apply these machine changes require one team to file tickets for another which takes a lot of time and effort. The grid supporting the automated tests is required to scale to thousands of machines and to be provisioned efficiently to support load shifts with test changes. The starting environment for tests needs to be clean to ensure that error reports for subsequent runs are not the result of environmental factors, resulting in costly developer debugging time. When performed manually, these processes may cause the following problems:

a) machine management—manual building or upgrading of a machine requires a lot of work and is error prone, which leads to expensive and unacceptable downtime (Example, it might take 2 weeks where 2 engineers work to upgrade 66 machines in batches of 5 machines, which is almost impossible to imagine when the grid has thousands of machines);

b) capacity management/provisioning—manual reallocation of machine resources with changing testing needs is slow and does not optimally utilize machines, leading to longer test times and under utilization of expensive machine resources;

c) Pristinification—manual resetting of the environment (e.g. data resets, memory allocation and process clean up, etc.) is slow and if not done leads to spurious errors, unrelated to code changes;

d) Differing codelines—a lot of work is required to manage software versions, as different environments can require different software versions (example some code lines may use oracle 9g, and some may use oracle 10g at the same time);

e) Changing Code velocity (code delivery rate)—moves across branches, if tests on these branches need different software versions, the machines have to be individually upgraded by filing tickets before allocating them across branches.

It is therefore desirable to provide systems and methods for automation of machine and grid management for software testing. It is also desirable that such systems and methods allow for rapid building, upgrading and resetting of testing environments that can be quickly provisioned across code lines for load balancing.

### BRIEF SUMMARY OF THE INVENTION

The present invention provides systems and methods for automated testing on virtual testing environments that are re-created after every test run. The present invention also provides systems and methods for managing large scale grids for test automation, machine management, and capacity management or provisioning.

According to various embodiments, systems and methods are provided for testing code checked in by developers into a change control management system. An automated process scans the change control management system for code changes, which then are downloaded and complied in preparation for testing. Several test feeds are then executed on the changed code to generate an error report to be provided back to the developers for bug fixes. The tests are run on a virtual testing environment, which is rebuilt after every test run. This achieves a fresh starting, or pristine, environment for every test run, ensuring that errors generated from any subsequent test runs are not due to environmental factors (e.g., spurious errors) and instead represent true code change errors for the developers to address, saving valuable developer debugging time.

Also according to various embodiments, systems and methods are provided to manage a grid of machines to support large scale, rapid, multi-developer testing environments. A small subset of machines in the grid are configured and built as template machines. These serve as the base machines to create the virtual testing environment from (e.g. database machines, application server machines, etc.). The template machines have different software versions and patches to support testing of multiple branches of code (e.g. Oracle 9g and 10g for the database template machines). Image templates are created from the template machines. The system allows for configuration of a number of virtual machine instances to be created per template image in order to meet testing requirements. The virtual instances are then automatically created in the specified numbers, ready to be used in the virtual testing environments for quality assurance processes.

Utilizing template and virtual testing machines allows for efficient machine management. Any software version upgrades or patch fixes are applied directly and only to the handful of template machines, which then get automatically propagated to the virtual instances when they are rebuilt. This avoids costly errors that occur in building and maintaining individual machines. Furthermore, using virtual instances allows for efficient capacity management. Virtual machine instances are re-allocated dynamically and incrementally as needed. After every test run, the virtual testing environment is destroyed and re-built. At this stage the virtual instance can be re-built using any of the underlying template machines, thus being re-allocated for use in any of the code line testing. In this way, virtual instances can be shifted rapidly and seamlessly to be used for testing different code branches as load balancing needs shift across code lines.

According to one embodiment a computer-implemented method of software testing in a multi-developer coding environment is provided. The method typically includes receiving a code change and creating a virtual testing environment by applying one or more image templates to a plurality of computing devices, testing the code change in the virtual testing environment to detect software errors and thereafter re-creating a new virtual testing environment by applying one or more of the image templates. By re-creating the environment after every test run, the next test run starts with a clean processor, memory and data space, ensuring that error reports are not caused by spurious environment-based errors. Also by using image templates instead of manual machine re-builds, costly human errors are avoided and the re-build is done very quickly, with reduced machine down time.

In certain aspects, creating a virtual testing environment includes creating virtual machine instances, and testing includes running the code change on the virtual machine instances. In certain aspects, the virtual testing environment includes a set of two virtual machine instances, an application software instance created by applying an application machine image template and a database instance created by applying a database machine image template.

In certain aspects, the receiving a code change is accomplished by synching changed code from a version control management system. In certain aspects, the code changes can be a multitude of changes checked in by one or more developers. In certain aspects, a portion of the testing of the code change is performed manually. And in certain aspects, test runs lead to receiving a set of errors that are communicated to one or more users or developers.

According to another embodiment a method of managing a plurality of machines for capacity and machine management is provided that includes creating a plurality of template machines, creating image templates from the template machines, assigning a number of virtual machine instances per image template, creating the number of virtual machine instances specified per image by applying the image template, and thereafter dynamically modifying the number of virtual machine instances per image. This method achieves rapid re-building of test environments, efficient machine management, and capacity management to scale and provision for a rapid development environment, requiring load shifting with changes in velocity of changes across code lines.

In certain embodiments, tangible, non-transitory computer-readable media are provided that store code, which when executed by one or more processors, implement the methods described above and herein. In certain aspects, such media include CDs, DVDs, hard drives or any other drives or storage mediums.

Continuous build and integration systems typical run tests (e.g., ftests) continuously, either triggered by checked in code changes or on demand. In either case, the accurate evaluation of test cases depends on environment factors and the state of data and code. Prior to embodiments herein, environment issues caused spurious test and build failures. These environment issues are common in a massively scalable automation infrastructure running up to millions of tests in a day continuously. They also occur due to errors in provisioning and configuration of automation applications on newly setup machines.

According to one embodiment, a DBRefresh process resets data to a given state (called gold db) after every test run. Before every test run, the process checks if the remote gold db has been updated and downloads the data file, if so. Whether or not the database schema has changed, the process unzips the data file before a test run. This ensures that the test run starts from clean data, hence the size of data file in a vm (virtual machine) remains checked and the test results are more reliable.

According to one embodiment, an environment fixer checks the available disk space, apache process, synchronization of NTP process, and other environmental conditions before starting a test run. If the fixer finds any environment issues it fixes such issue(s) automatically, so the test run can execute without reliability issues.

According to one embodiment, a dbchecker/fixer checks various aspects of oracle processed on the machine hosting DB.

Various embodiments enable execution of millions of tests on every changelist on a large scale infrastructure that protects the tests from environment issues and recovers automatically. Another benefit of embodiments is that they serve as a determination test if the machines setup with automated builds have configuration or provisioning errors, which can lead to spurious test failures.

Every build or autobuild or release process would synchronize the code from perforce and compile it into a jar (e.g., code and test data) that is deployed separately. Due to this, sometimes the code that is shipped could be different from code that was tested. This also caused inefficient utilization of resources.

According to one embodiment, an autobuild process synchronizes and compiles code, and generates artifacts for a particular branch. Reset ftest autobuilds to run in consumer mode, where they start the test run after the artifact has been generated, and use and download that artifact. Update the manual build testing environment and deploy processes to use the artifact for release and deployment, thereby enabling the same entity to be tested and released to production.

The various embodiments described above are particularly useful in a testing environment related to software to manage and run an on-demand database system as well as for software applications that are created and released for use by external users of the on-demand database system.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### BRIEF DESCRIPTION OF THE DRAWINGS

FIG. 1 illustrates a large scale test automation grid system according to one embodiment.

FIG. 2 illustrates an automation test cycle according to one embodiment.

FIG. 3 illustrates a method of building a test automation grid system according to one embodiment.

FIG. 4 illustrates a block diagram of an environment wherein an on-demand database service might be used.

FIG. 5 illustrates a block diagram of an embodiment of elements of FIG. 1 and various possible interconnections between these elements according to an embodiment of the present invention.

### DETAILED DESCRIPTION OF THE INVENTION

The present invention provides systems and methods for automated testing on virtual testing environments that are re-created after every test run. The present invention also provides systems and methods for managing large scale grids for test automation, machine management, and capacity management or provisioning.

According to various embodiments, systems and methods are provided for testing code checked in by developers into a change control management system. An automated process scans the change control management system for code changes, which then are downloaded and complied in preparation for testing. Several test feeds are then executed on the changed code to generate an error report to be provided back to the developers for bug fixes. The tests are run on a virtual testing environment, which is rebuilt after every test run. This achieves a fresh starting, or pristine, environment for every test run, ensuring that errors generated from any subsequent test runs are not due to environmental factors (e.g., spurious errors) and instead represent true code change errors for the developers to address, saving valuable developer debugging time.

Also according to various embodiments, systems and methods are provided to manage a grid of machines to support large scale, rapid, multi-developer testing environments. A small subset of machines in the grid are configured and built as template machines. These serve as the base machines to create the virtual testing environment from (e.g. database machines, application server machines, etc.). The template machines have different software versions and patches to support testing of multiple branches of code (e.g. Oracle 9g and 10 g for the database template machines). Image templates are created from the template machines. The system allows for configuration of a number of virtual machine instances to be created per template image in order to meet testing requirements. The virtual instances are then automatically created in the specified numbers, ready to be used in the virtual testing environments for quality assurance processes.

Utilizing template and virtual testing machines allows for efficient machine management. Any software version upgrades or patch fixes are applied directly and only to the handful of template machines, which then get automatically propagated to the virtual instances when they are rebuilt. This avoids costly errors that occur in building and maintaining individual machines. Furthermore, using virtual instances allows for efficient capacity management. Virtual machine instances are re-allocated dynamically and incrementally as needed. After every test run, the virtual testing environment is destroyed and re-built. At this stage the virtual instance can be re-built using any of the underlying template machines, thus being re-allocated for use in any of the code line testing. In this way, virtual instances can be shifted rapidly and seamlessly to be used for testing different code branches as load balancing needs shift across code lines.

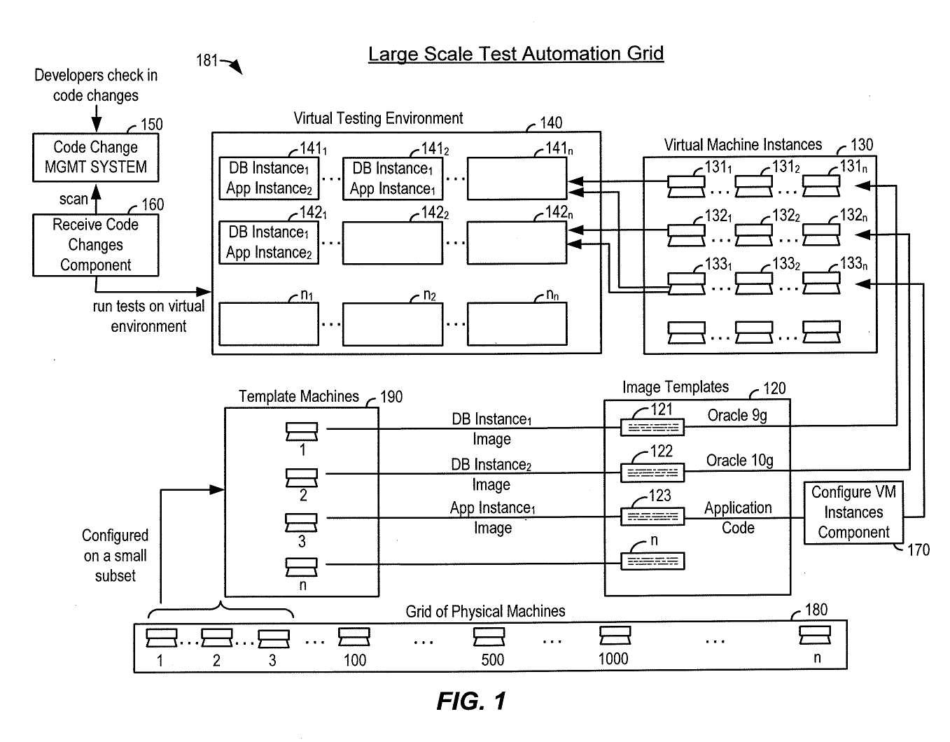

FIG. 1 illustrates a large scale test automation grid 181 according to one embodiment. The physical machines 180₁ to 180ₙ are used to configure template machines 190₁ to 190ₙ. The template machines 190 are then used to create a set of template images 120, which are used to create a set of virtual machine instances 130 using the numbers specified in the configuration block 170. The template images for example may be created for a DBinstance₁ 121 (e.g. Oracle 9g machine), DBinstance₂ 122 (e.g. Oracle 10g machine), and AppInstance₁ 123 (e.g. Application code machine). The two versions of the database machines may exist to support testing on different code lines. The virtual machines instances 130 will then be created in the numbers specified by the configure VM instances module 170. Module 170 allows a user of the system to configure the number of instances of the virtual machine instances 130 to be created per image 120. This is typically done by a member of the test automation or grid management team. As an example per the configuration parameters supplied in module 170, virtual instances 131₁-131ₙ may be created and available for tests requiring Oracle 9g, instances 132₁-132ₙ created and available for tests requiring Oracle 10g, and instances 133₁-133ₙ created and available for tests requiring an application code machine. Application code machine may have application server code installed and/or actual client application code installed on it.

The virtual machine instances 130 then are used in a set of virtual testing environments 140, each generally including at least a database virtual machine instance and an application virtual machine instance. For example, virtual testing environment 141₁-141ₙ may include an Oracle 9g DBinstance 131 and an AppInstance 133, while virtual testing environment 142₁-142ₙ may include an Oracle 10 g DBinstance and an AppInstance 133. The various virtual testing environments will then be typically available for testing code changes on different code lines. Developers check in code changes into the code change management system 150 which is used by component 160 to receive code changes for testing on the virtual testing environment 140.

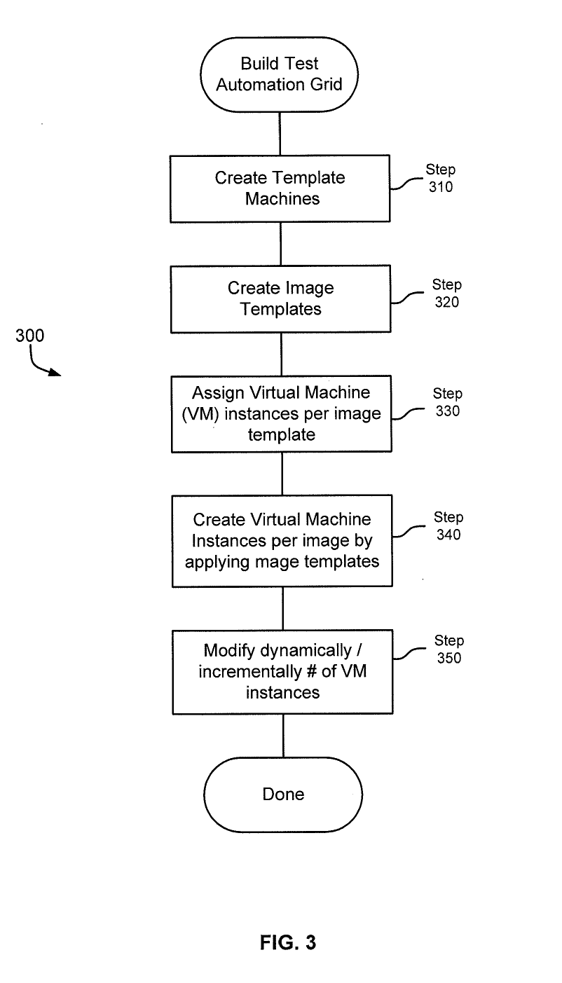

FIG. 3 illustrates a method 300 of creating and managing a large scale test automation grid, such as grid 181. In step 310, a plurality of template machines are created. This is done on physical machines 180 by for example installing the required operating system and software (e.g. database, application software, etc.) that is required for testing for the various branches of code. For example, one template machine 190 may have Oracle 9g installed on it, while a different template machine 190 may have Oracle 10 g installed on it, while yet another may have application server code installed on it. Template machines 190 are generally a small subset of the total number of machines in a grid. Any one template machine can have multiple software applications installed with any desired environment configurations. Furthermore, any software version upgrades or patch fixes that need to be applied are directly applied to one or more of the template machines. These changes are automatically propagated to the virtual machine instances 130 when they are re-created from updated image templates 120. Such machine management being restricted only to the template machines is important in avoiding human errors in machine rebuilds and allows for more robust testing environments. It advantageously also facilitates scalability because only a small number of template machines need to be maintained.

After the template machines 190 are created, in step 320 image templates are created from the template machines to be used in creating virtual machine instances 130. In step 330, a number of virtual machine instances are assigned per image type. In step 340 virtual machines instances are created by applying the image templates created in step 320, per the specified number of instances per image identified in step 330. Once the virtual machine instances are created, they are used in a virtual testing environment 140. In a preferred embodiment a virtual testing environment includes two instances, a database instance 131 or 132 and an application instance 133, for running code change tests upon.

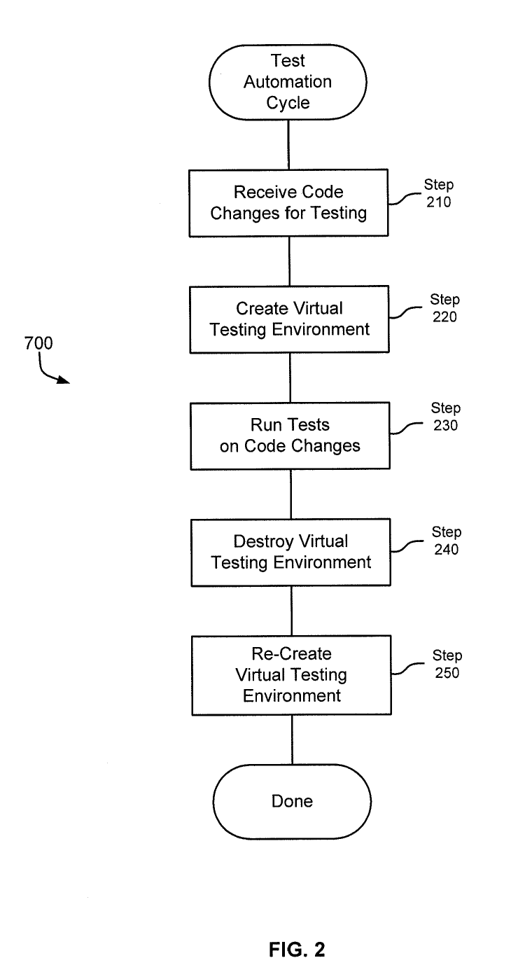

Advantageously, method 300 allows for capacity management. Once virtual machines are built from images, the numbers of such instances can be modified dynamically and incrementally in step 350. This can be achieved either by assigning a different number of instances in step 350 for re-building of virtual machine instances or incrementally as resources free up in step 250 of FIG. 2 (discussed below), upon the destruction and re-creation of a testing environment.

In one embodiment, the system of FIG. 1 is implemented using link clone technology. The system still includes creating template machines and creating images from the template machines, but each virtual instance 130 is a clone that is linked to a particular image 120. This facilitates shorter times for re-creating a virtual machine instance after a test run (e.g., on the order of 1 minute to re-create using link clones vs. 10-20 minutes using virtual images). Also, link clone technology allows for better machine resource utilization and scalability because machines or clones can be easily linked to other image types on the fly as capacity needs change across code lines with minimal down time. In certain aspects, the link clone technology is implemented using VMWare software.

FIG. 2 illustrates a method 200 for implementing a test automation cycle run on the test automation grid of FIG. 1 according to one embodiment. Code changes are received for testing in step 210. In step 220, a virtual testing environment is created to run the tests on as specified in step 230. After the testing run, the virtual testing environment is destroyed in step 240, and is re-created in step 250 and made available for the next test run. Doing this provides pristinification of the environment; re-creating of the virtual testing environment after every test run ensures that all old processes and memory are cleaned up and the data state is restored to a fresh starting state. This is important to avoid error reports generated due to environmental factors, known as spurious errors. Spurious errors lead to costly developer debugging time, only to discover that it was not their code change that resulted in the error but an environmental factor. By resetting the virtual testing environment after every test run, a clean test environment state is ensured at the start of every test run.

Code changes are checked into change control management system 150. One embodiment of such a system is Perforce. Perforce is a version and change control management system that is well known to one skilled in the art. It is used for example to maintain software code and for developers to check in any subsequent changes to the code, with automatic versioning of the changes. In one aspect, the receive code change component scans the code change system for code changes and synchronizes test code with Perforce by downloading the code change and compiling the code change in preparation for test runs. Code changes can include one or more changes checked in during the course of one or more days. Code changes can be checked in by multiple developers. Typically a test run will include multiple changes from multiple developers. Test runs are typically automated testing, but can also include manual test runs executed or initiated by a user. Also, in one aspect, an error report is generated after the test run which is then communicated to the developers for code and bug fixes, e.g., by email.

The automation team supports testing of various code lines at any one point. For example, one code branch can be for testing only production code for bugs, another for a code branch that is testing bugs for code ready to be released, yet another code line for currently developed code being tested for any code breaks. These differing code lines generally require different software versions for testing (e.g. Oracle 9g for production and Oracle 10 g for development branch). Therefore, step 220 for creating a virtual testing environment depends on which line of code is being tested. This need for supporting different environments for testing different code lines, is advantageously facilitated by the present invention. Only the template machines need to have the differing software versions installed thereon, while the virtual instances or clones use the images or link to the image created from the underlying template machines.

In one embodiment, the virtual testing environment 140 includes a database virtual machine instance and an application virtual machine instance. Furthermore, the virtual testing environment can include different versions of the virtual database machine instance to support testing on different branches of code. For example, a production code line test may require a virtual database instance with Oracle 9g installed, while a new release code line may require testing on a virtual machine instance with Oracle 10g installed.

In certain embodiments, the testing systems and methods described above are particularly useful in multi-tenant database system or environment, for example, for use in testing code to be used in or by the multi-tenant database system or code that is used as part of the multi-tenant database system code environment.

As used herein, the term multi-tenant database system or service or environment refers to those systems in which various elements of hardware and software of the database system may be shared by one or more customers. For example, a given application server (e.g. running an application process) may simultaneously process requests for a great number of customers, and a given database table may store rows for a potentially much greater number of customers. As used herein, the terms query or query plan refer to a set of steps used to access information in a database system.

### System Overview

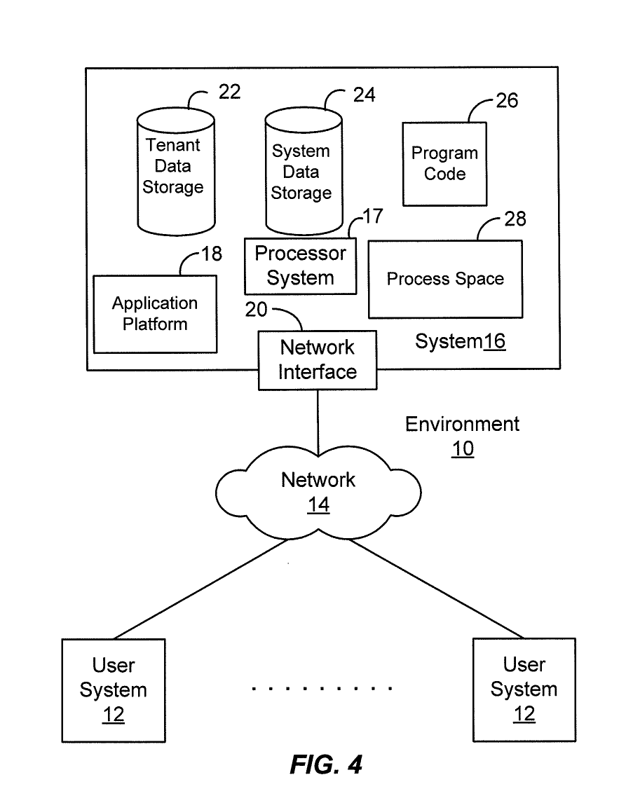

FIG. 4 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

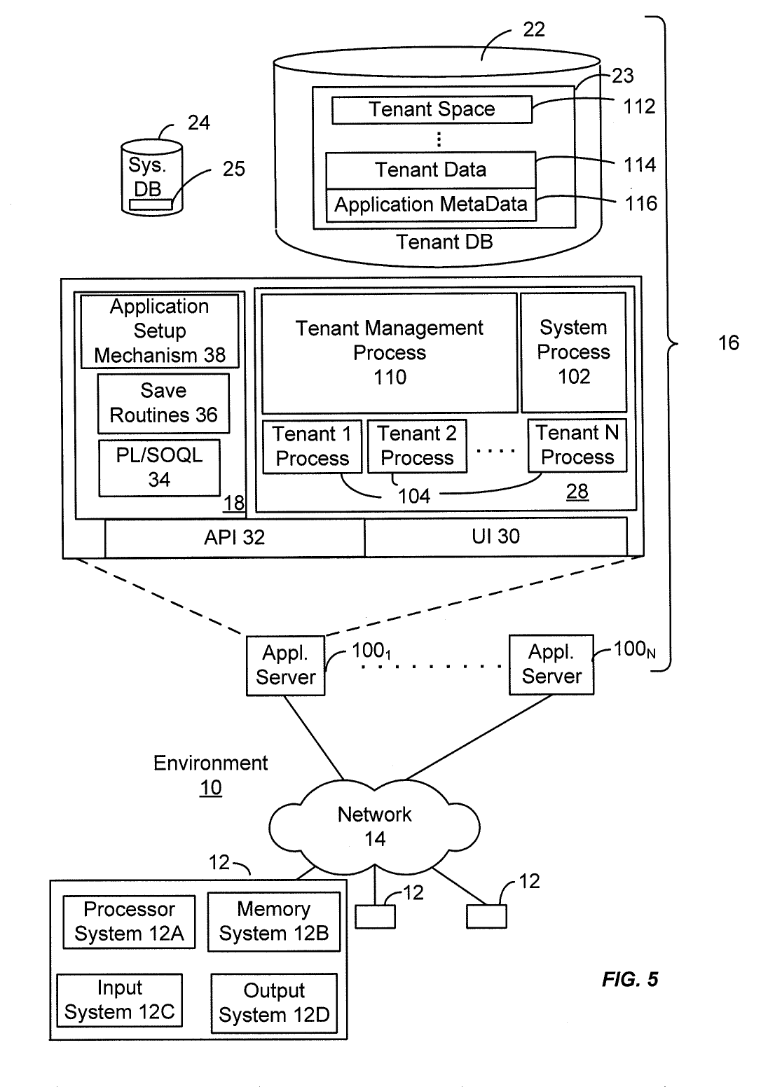

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 4 (and in more detail in FIG. 5) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 4, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 4 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 5 also illustrates environment 10. However, in FIG. 5 elements of system 16 and various interconnections in an embodiment are further illustrated. FIG. 5 shows that user system 12 may include processor system 12A, memory system 12B, input system 12C, and output system 12D. FIG. 5 shows network 14 and system 16. FIG. 5 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 4. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 4) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. Yet another table or object might describe an Opportunity, including fields such as organization, period, forecast type, user, territory, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of software testing in a multi-developer coding environment comprising:
receiving a code change;
creating a virtual testing environment by applying one or more image templates to a plurality of computing devices;
testing the code change in the virtual testing environment to detect software errors; and
thereafter re-creating a new virtual testing environment by applying one or more of said image templates.

2. The method of claim 1 wherein the step of creating a virtual testing
environment includes creating virtual machine instances, and wherein the step of testing includes running the code change on the virtual machine instances.

3. The method of claim 1 wherein the virtual testing environment comprises a set of two virtual machine instances, an application software instance created by applying an application machine image template and a database instance created by applying a database machine image template.

4. The method of claim 1 further comprising:
creating one or more template machines; and
creating one or more image templates from the template machines.

5. The method of claim 3 further comprising, performing a database refresh process that resets the data of the database instance to the disk data state of a database template machine.

6. The method of claim 1 wherein the step of re-creating a new virtual testing environment includes destroying the virtual testing environment.

7. The method of claim 1 wherein the code change includes one or more code changes checked in by one or more developers.

8. The method of claim 1 wherein a portion of the testing of the code change is performed manually.

9. The method of claim 1 wherein the receiving a code change is accomplished by synching changed code from a version control management system.

10. The method of claim 1 further comprising:
receiving a set of errors from the testing; and
communicating the set of errors to one or more users or developers.

11. A method of managing a plurality of machines for capacity and machine management comprising:
creating a plurality of template machines;
creating image templates from the template machines;
assigning a number of virtual machine instances per image template;
creating the number of virtual machine instances specified per image by applying the image template; and
thereafter dynamically modifying the number of virtual machine instances per image.

12. The method of claim 11 wherein the step of modifying the number of virtual machine instances per image template is performed incrementally as system resources free up.

13. The method of claim 11 further comprising, performing system upgrades and fixes by applying the upgrades and fixes directly to one or more of the image template machines for automatic propagation to the virtual machine instances.

14. The method of claim 11 wherein the template machines have different software versions to support different branches of code lines.
